(19) United States
(12) Patent Application Publication
(10) Pub. No.: US 2002/0117524 A1
(43) Pub. Date: Aug. 29, 2002

(54) Trunk mountable equipment rack

(76) Inventor: Chanyoung Jeong, Cerritos, CA (US)

Correspondence Address: OPPENHEIMER WOLFF & DONNELLY LLP, Suite 3800, 2029 Century Park East, Los Angeles, CA, 90067, US

(21) Appl. No.: 09/795,682

(22) Filed: Feb. 28, 2001

(51) Int. Cl. B60R 9/10; B60R 9/06

(52) U.S. Cl. 224/314; 224/497; 224/502; 224/493; 224/532; 224/329

(57) ABSTRACT

A trunk-mountable equipment rack includes a frame having a cross member and a plurality of legs. The legs have straps attached that are capable of extending to couple the legs to the trunk of a vehicle. These straps allow the equipment rack to be placed on and secured to different sizes and shapes of trunks of vehicles. The invention also includes support bars for securing equipment to the equipment rack for transportation on a vehicle.

### BACKGROUND OF THE INVENTION

1. Field of the Invention

The present invention relates generally to equipment racks. Specifically, the invention relates to equipment racks that are adjustable and capable of holding sports equipment such as bicycles and skis, and that also mount and secure to vehicles for transportation.

2. General Background and State of the Art

There are many prior art equipment racks that mount on vehicles for the transportation of sports equipment and other articles. One such equipment rack, disclosed in U.S. Pat. No. 5,495,970, includes several structures removably mounted around a shaft. These structures are removable from the shaft and replaceable to create different angular positions relative to the shaft. However, the angles created by repositioning the structures are limited, and the removability of the structures creates a potentially cumbersome apparatus that hinders quick and easy handling.

Another prior art equipment rack, disclosed in U.S. Pat. No. 5,211,323, includes a pair of mounting members for mounting to a vehicle and supporting arms connected to the mounting members. The mounting members are pivotally connected for rotation between a plurality of adjusted positions. Yet another prior art equipment rack is disclosed in U.S. Pat. No. 5,135,145, which discloses a heavy duty bicycle rack having support legs with limited angular movement. The invention also includes support arms for holding bicycles which are adjustable without having to the adjust the position of the legs. Both of these patents feature racks that have structural components which pivot relative to each other, limiting the positions in which the rack can be placed on a vehicle. Furthermore, there is no centralized frame around which all structural and support components move.

### INVENTION SUMMARY

The present invention improves upon the prior art by providing a mountable equipment rack having a plurality of legs connected to a cross member. The invention includes at least one equipment support bar for placing equipment such as bicycles and skis on the mountable equipment rack. The legs include a pair of front legs and a pair of rear legs. The rear legs and the equipment support bar are rotatable relative to the cross member for storing in a compact position or maneuvering to a desired position, depending on the size of the trunk onto which the equipment rack will be placed. The front legs are fixed relative to the cross member.

Particular embodiments of the invention also include a plurality of strap housing assemblies coupled to the legs that have retractable straps capable of securing the mountable equipment rack to a vehicle. Each strap housing assembly includes a cover, a retractable strap and a securing mechanism. Each retractable strap can be pulled out to couple a leg to the trunk of a vehicle and retracted back into the strap housing assembly. Therefore, the mountable equipment rack is easily placed onto and removable from a trunk of a vehicle.

Accordingly, it is an object of the invention to provide an equipment rack that is easily mountable on vehicles. One embodiment of the invention provides an equipment rack that is adjustable to conform to different types of vehicles, and which has structural members that are adjustable to fit different mounting positions. Other embodiments of the invention may also provide an equipment rack that is easily securable to a vehicle for the transportation of equipment. The equipment rack may also be adjustable for compact storage. Further objects and features of the invention will be apparent from the drawings, the detailed description and the claims.

### BRIEF DESCRIPTION OF THE DRAWINGS

FIG. 1 is a perspective view of a mountable equipment rack in a secure position on the trunk of a vehicle;

FIG. 2 is a side view of the mountable equipment rack with an equipment support bar in an extended position;

FIG. 3 is a front view of the mountable equipment rack;

FIG. 4 is an additional front view of the mountable equipment rack;

FIG. 5 is a rear view of the mountable equipment rack;

FIG. 6 is an additional rear view of the mountable equipment rack;

FIG. 7 is a perspective view of the mountable equipment rack in a stored position;

FIG. 8 is a close-up perspective view of a positioning assembly of the mountable equipment rack;

FIG. 9 is an additional close-up view perspective of a positioning assembly of the mountable equipment rack; and

FIG. 10 is an overhead view of a positioning assembly of the mountable equipment rack.

### DETAILED DESCRIPTION OF THE EMBODIMENTS

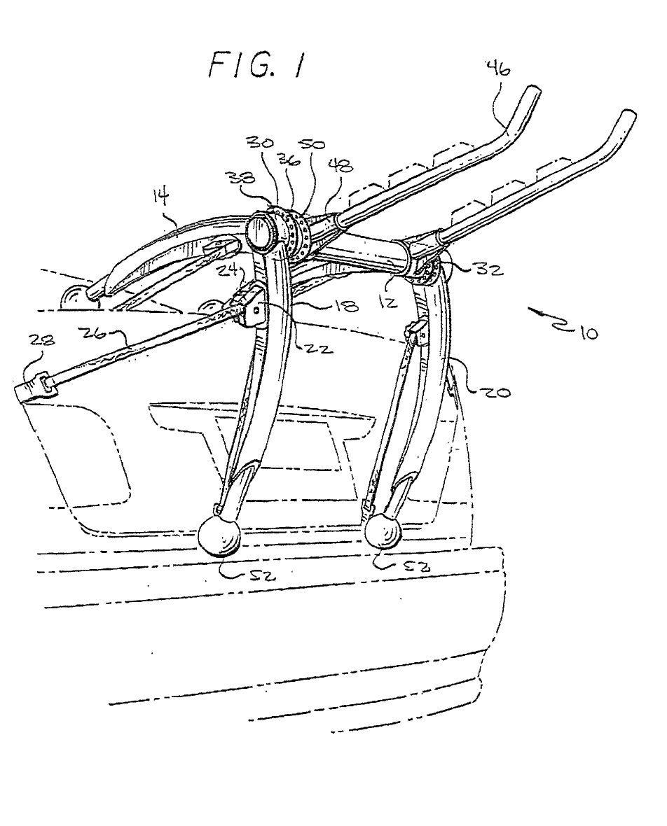

FIG. 1 shows a mountable equipment rack 10 having a cross member 12 disposed between a plurality of arcuately oriented legs, secured to the trunk of a vehicle. The plurality of legs includes a first rear leg 14, a second rear leg 16, a first front leg 18, and a second front leg 20. Although the legs are shown as arcuately shaped in FIG. 1, they may be straight or curved, and additionally the legs do not all need to be of the same shape. Each leg is coupled at one end to the cross member 12. The mountable equipment rack 10 also includes at least one strap housing assembly 22. Each strap housing assembly 22 includes a cover 24, a retractable strap 26 and a securing piece 28. As shown in FIG. 1, each retractable strap 26 is extended so that the securing piece 28 attached to each retractable strap 26 releasably secures the mountable equipment rack 10 to a part of the trunk of the vehicle. Each strap housing assembly 22 may also include a knob that can be turned to facilitate the retraction of a retractable strap 26 when not in use. The retractable straps 26 may be made of any material that is of sufficient strength to provide secure support for the equipment rack on a vehicle. The number of strap housing assemblies 22 used to secure the mountable equipment rack 10 to a trunk varies depending on the level of security desired. The invention contemplates that any number of strap housing assemblies 22 may be used to releasably secure the mountable equipment rack 10 to a vehicle. A strap housing assembly 22 is coupled to the mountable equipment rack 10 by either removably attaching to a leg or by fixedly attaching to a leg. A leg on which a strap housing assembly 22 is placed may have one or many of such strap housing assemblies. The invention contemplates that at least one strap housing assembly 22 is used to releasably secure the mountable equipment rack 10 to a vehicle. In one embodiment, each leg includes at least one strap housing assembly 22. In another embodiment, the invention includes more legs than there are strap housing assemblies 22, such that not every leg has a strap housing assembly coupled thereto.

The mountable equipment rack 10 also includes a first axially oriented positioning assembly 30 disposed on said cross member 12 and a second axially oriented positioning assembly 32, also disposed on said cross member 12. Each of the axially oriented positioning assemblies 30 and 32 include a rotatable member 34 having a first rotatable ring 36 and a fixed member 38. The rotatable member 34 of the first axially oriented positioning assembly 30 is coupled to the first rear leg 14. Similarly, the rotating member 34 of the second axially oriented positioning assembly 32 is coupled to the second rear leg 16. The fixed member 38 of the first axially oriented positioning assembly 30 is coupled to the first front leg 18, and the fixed member 38 of the second axially oriented positioning assembly 32 is coupled to the second front leg 20. Thus, each of the fixed members 38 fixedly couple a front leg to the cross member 12.

Each axially oriented positioning assembly 30 and 32 may also include a support bar member 48 having a second rotatable ring 50. The mountable equipment rack 10 also includes at least one equipment support bar 46 coupled to the support bar member 48. In one embodiment, the mountable equipment rack 10 includes two equipment support bars 46, each equipment support bar 46 coupled to a support bar member 48 having a second rotatable ring 50. In this embodiment, each support bar member 48 and second rotatable ring 50 are axially coupled to the cross member 12. Therefore, the support bar members 48 and second rotatable rings 50 to which they are attached rotate together to allow the equipment support bar 46 to rotate relative to the cross member 12. All first and second rotatable rings 36 and 50 have a plurality of holes. The plurality of holes allow a locking pin to be inserted between said holes to lock the first and second rotatable rings in place so that they can no longer rotate when the mountable equipment rack 10 is in use. Thus, the locking pins prevent the rings from moving, thereby securing the rear legs 14 and 16 as well as the equipment support bar 46 in place.

FIG. 1 also shows a plurality of traction members 52 coupled to distal ends of each of the front and rear legs. These distal ends are opposite to the ends of the front and rear legs that couple to the cross member. The traction members 52 provide additional support for each of the front and rear legs and prevent movement of the legs when mounted on a vehicle. The traction members 52 also prevent damage to the vehicle on which the mountable equipment rack 10 is placed, such as denting, scratching or the chipping of paint. The plurality of traction members 52 may be spherical in shape and may be made of rubber. However, it is to be understood that the plurality of traction members may be of any shape and may be made of any material suitable for the purposes for which the traction members are used. For example, the traction members may be made of foam and made be square in shape.

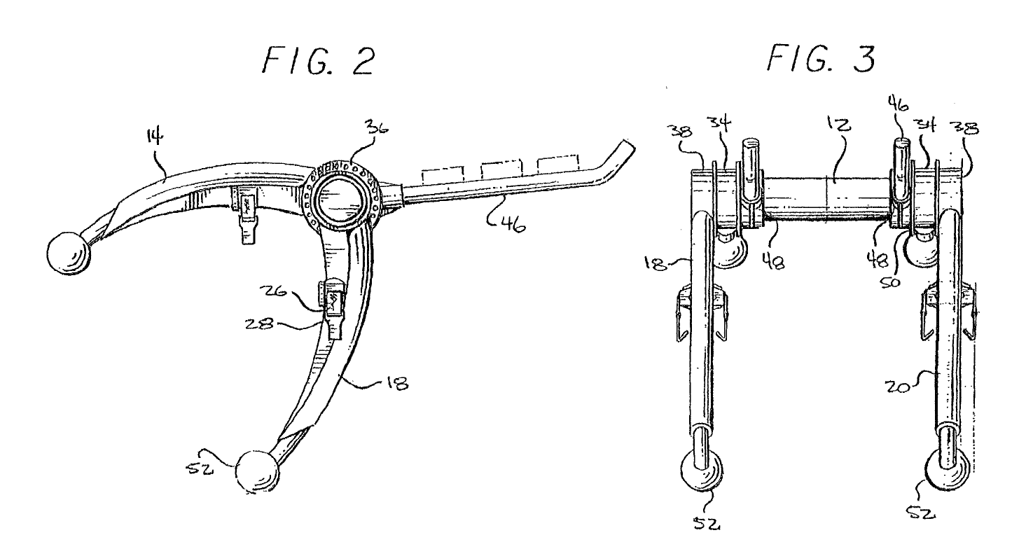

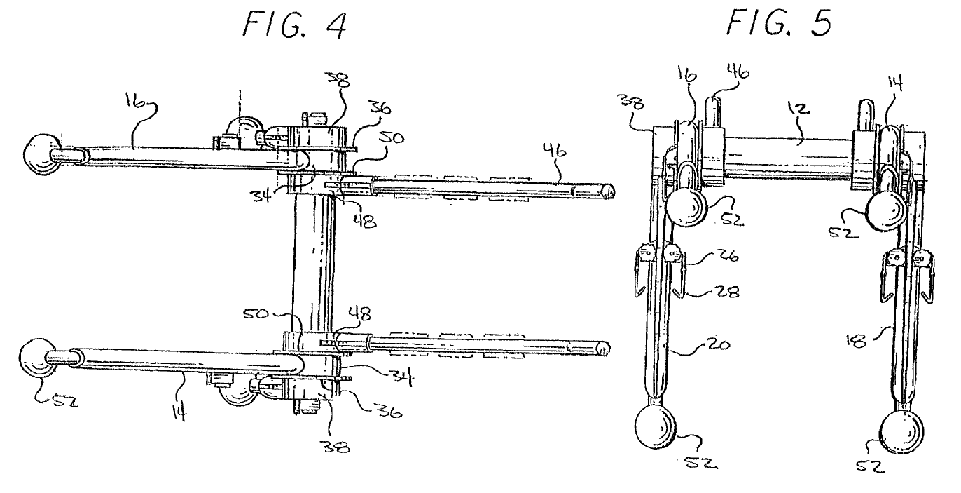

FIG. 2 shows a side view of the mountable equipment rack 10. In FIG. 2, the retractable straps 26 and securing mechanisms 28 are shown retracted into the strap housing assemblies 22 such that they are not securing the mountable equipment rack 10 to a trunk of a vehicle. FIG. 3 shows a front view of the mountable equipment rack 10. Both views in FIG. 2 and FIG. 3 show the positioning of the front and rear legs as they would generally be if they were positioned on a vehicle for storage of equipment. FIG. 4 shows a rear view of the mountable equipment rack 10. FIG. 4 also shows the range of movement over which the equipment support bars 42 can rotate relative to the cross member 12. FIG. 5 shows a rear view of the mountable equipment rack 10, in a position similar to that of FIG. 3.

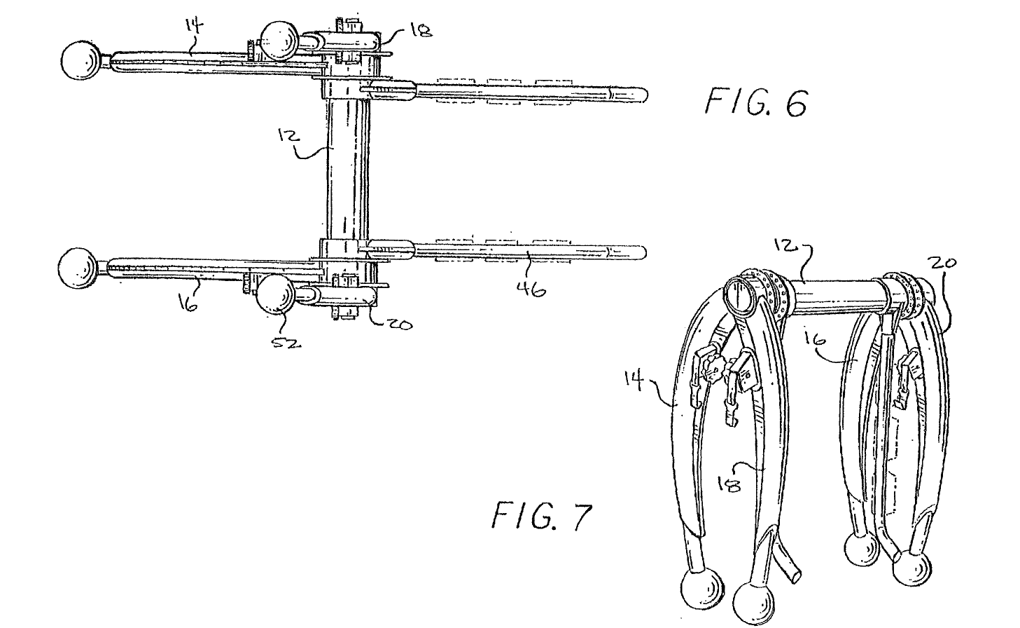

FIG. 6 shows a front view of the mountable equipment rack 10 with the equipment support bars 46 rotated at a higher angle than that shown in FIGS. 2 and 3. FIG. 6 also shows the ability of the equipment support bars 46 to rotate relative to the cross member 12. By removing the locking pins that hold the rotatable rings together, the equipment support bars 42 are able to rotate relative to the cross member 12 to a position as desired by a user. FIG. 7 shows the mountable equipment rack 10 in a stored position. In this stored position, the locking pins, when removed from the rotatable rings, allow the rear legs and equipment support bars to rotate to a position in which the front and rear legs are positioned close together and the equipment support bars are positioned close to both the rear and front legs. By placing the locking pins back through the holes in the rotatable rings, the mountable equipment rack 10 can be easily carried in the position shown in FIG. 7 and stored.

The cross member 12 of the mountable equipment rack 10 is made of metal. In one embodiment, the metal used to make the cross member 12 is aluminum. The front and rear legs of the mountable equipment rack 10 are made of any material strong enough to support articles placed on the equipment support bar 46. In one embodiment, the materials used to make the front and rear legs are a substance comprising 80% polypropylene and 20% glass. The rotatable rings may also be made of a metal, for example aluminum.

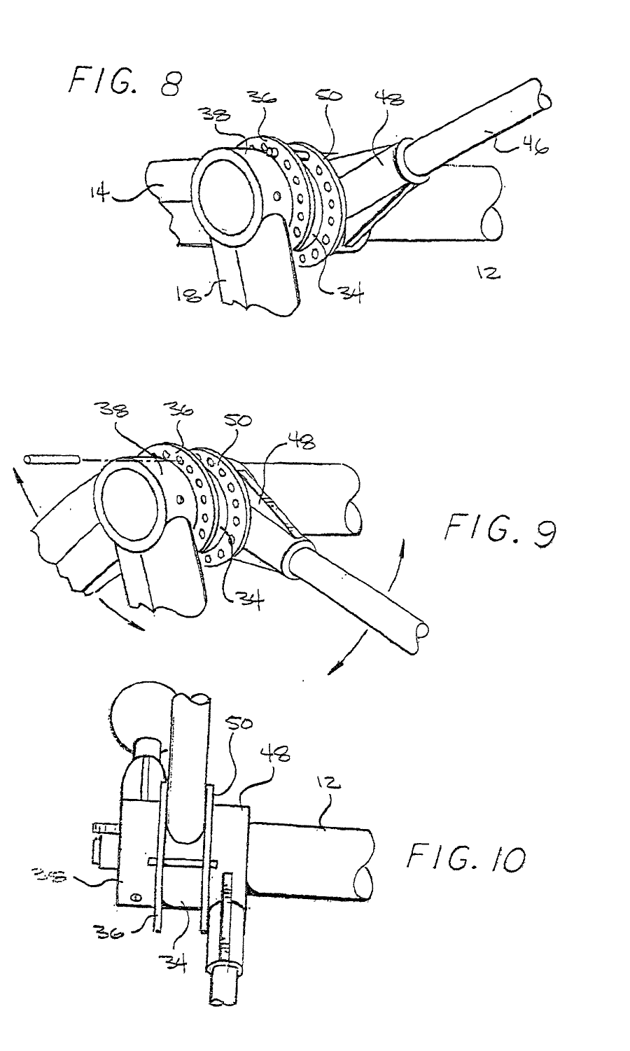

FIG. 8 is a close-up perspective view of a positioning assembly on the cross member 12 of the mountable equipment rack 10. As described above, each positioning assembly includes a support bar member 48 having a second rotating ring 50, a rotatable member 34 having a first rotating ring 36, and a fixed member 38. The fixed member 38 includes a front leg, while the rotatable member 34 includes a rear leg. The fixed member 38 and front leg are fixedly coupled to the cross member 12 and do not rotate around the cross member 12. The rotating member 34 and rear leg are rotatably coupled to the cross member 12. The support bar member 48 couples to an equipment support bar 46. FIG. 9 is a close-up perspective view of a positioning assembly with the equipment support bar 46 positioned lower than that shown in FIG. 8, and the rear leg also positioned lower than that shown in FIG. 8.

FIG. 10 is an overhead view of a positioning assembly of the mountable equipment rack 10. This view shows the equipment support bar 46 and support bar member 48 in a locked position, with a locking pin placed through the second rotating ring 50 of the support bar member 48 and through the first rotating ring 36 of the rotatable member 34. This secures both the rear leg and the equipment support bar 46 for sturdy use on a vehicle.

The foregoing presents particular embodiments of the invention. However, various alternatives fall within the scope of the invention. For example, the retractable straps of the strap housing assemblies may be elastic bands that stretch from a relaxed position to couple the legs to a vehicle. Also, the securing pieces may include hooks that releasably secure the legs to a vehicle. In another example, the rear legs may fixedly couple to the cross member while the front legs rotatably couple to the cross member. Consequently, the invention is not limited to the specific embodiments described herein.

We claim:

1. An equipment rack mountable in a secure fashion to a vehicle trunk, the equipment rack comprising:
a frame having a cross member disposed between a plurality of legs, said legs including rear legs and front legs;
a plurality of strap housing assemblies coupled to the front and rear legs for securing the frame to a vehicle; and
at least one equipment support bar, the at least one equipment support bar coupled to the cross member.

2. The rack of claim 1, wherein the front legs and rear legs each have a first end coupled to the cross member.

3. The rack of claim 1, wherein the at least one equipment support bar is rotatably coupled to the cross member.

4. The rack of claim 1, further comprising a first axially oriented positioning assembly disposed on said cross member and a second axially oriented positioning assembly disposed on said cross member, each positioning assembly including a pair of rings each having a plurality of holes.

5. The rack of claim 4, wherein each positioning assembly further comprises a rotatable member and a fixed member, each rotatable member including a rear leg and each fixed member including a front leg.

6. The rack of claim 5, wherein each rotatable member and rear leg are rotatably coupled to the cross member.

7. The rack of claim 5, wherein each fixed member and front leg are fixedly coupled to said cross member.

8. The rack of claim 1, wherein the front legs include a first front leg and a second front leg, and the rear legs include a first rear leg and a second rear leg.

9. The rack of claim 1, wherein said front legs are fixedly disposed substantially parallel to each other.

10. The rack of claim 1, wherein said strap housing assemblies each include a retractable strap and a securing piece disposed on an end of each retractable strap.

11. The rack of claim 2, further comprising a plurality of traction members disposed on distal ends of the front and rear legs.

12. The rack of claim 5, further comprising at least one support bar member, the support bar member rotatably coupling the at least one equipment support bar to the cross member.

13. The rack of claim 12, wherein the support bar member is rotatable relative to the cross member.

14. The rack of claim 13, further comprising a locking pin insertable between the holes of said plurality of rings, the locking pin being insertable to fixedly couple said support bar member and said rotatable member to said fixed member.

15. The rack of claim 1, wherein the rear legs are angularly positionable relative to the cross member to adjust to different angles of mounting.

16. The rack of claim 1, wherein the at least equipment support bar is angularly positionable relative the cross member to adjust for different angles of mounting and different types of equipment to be stored.

17. A mountable equipment rack for a vehicle trunk, the mountable equipment rack comprising:
a pair of arcuately oriented front legs operatively disposed to a pair of arcuately oriented rear legs; and
at least one strap housing assembly coupled to a leg.

18. The rack of claim 17, further comprising a cross member perpendicularly disposed between said pair of front legs and said pair of rear legs.

19. The rack of claim 18, further comprising at least one equipment support bar rotatably coupled to said cross member.

20. The rack of claim 18, wherein the rear legs each have a first end rotatably coupled to the cross member, and the front legs each have a first end fixedly coupled to the cross member.

21. The rack of claim 18, further comprising a first axially oriented positioning assembly disposed on said cross member and a second axially oriented positioning assembly disposed on said cross member, each positioning assembly having a pair of rings with a plurality of holes thereon.

22. The rack of claim 18, further comprising a plurality of strap housing assemblies fixedly coupled to said front and rear legs, each of the plurality of strap housing assemblies including a retractable strap and a securing piece disposed on an end of said retractable strap, the securing piece configured to releasably couple to an edge of a trunk.

23. The rack of claim 18, wherein the at least one equipment support bar is rotatably coupled to the cross member.

24. The rack of claim 21, wherein each positioning assembly further comprises a rotatable member and a fixed member, each rotatable member including a rear leg and each fixed member including a front leg.

25. The rack of claim 24, wherein each rotatable member and rear leg are rotatably coupled to the cross member.

26. The rack of claim 17, wherein said front legs are fixedly disposed substantially parallel to each other.

27. The rack of claim 17, wherein the front legs include a first front leg and a second front leg, and the rear legs include a first rear leg and a second rear leg.

28. The rack of claim 21, wherein said fixed members and front legs are fixedly coupled to said cross member.

29. The rack of claim 17, further comprising a plurality of traction members disposed on distal ends of the front and rear legs.

30. The rack of claim 21, further comprising at least one support bar member, the support bar member rotatably coupling the at least one equipment support bar to the cross member.

31. The rack of claim 24, wherein the support bar member is rotatable relative to the cross member.

32. The rack of claim 30, further comprising a locking pin insertable between the holes of said plurality of rings, the locking pin being insertable to fixedly couple said support bar member and said rotatable member to said fixed member.

33. The rack of claim 18, wherein the rear legs are angularly positionable relative to the cross member to adjust to different angles of mounting.

34. The rack of claim 19, wherein the at least equipment support bar is angularly positionable relative the cross member to adjust for different angles of mounting and different types of equipment to be stored.

35. A method of storing equipment on a vehicle, the method comprising:
providing a frame having a plurality of legs including front and rear legs, the front legs being oppositely disposed to the rear legs, and a plurality of strap housing assemblies coupled to said front and rear legs;
securing the plurality of legs to a vehicle; and
positioning at least one equipment support bar relative to said front and rear legs, the equipment support bar being capable of holding at least one piece of equipment.

36. The method of claim 35, further comprising rotatably coupling the rear legs to a cross member, the cross member including a pair of axially oriented positioning assemblies, each assembly having a rotating member coupling a rear leg to the cross member.

37. The method of claim 36, further comprising fixedly coupling the front legs to the cross member, each axially oriented positioning assembly having a fixed member coupling a front leg to the cross member.

38. The method of claim 37, further comprising rotatably coupling the at least one equipment support bar to the cross member, each axially oriented positioning assembly having a support bar member coupling the at least one equipment support bar to the cross member.

39. The method of claim 38, further comprising coupling the support bar member and rotatable bar member to the fixed member with a removable locking pin, the locking pin being removable to allow the rear legs to be rotated relative to the cross member.

40. The method of claim 36, further comprising angularly positioning the rear legs relative the cross member, the rear legs being angularly positionable for different angles of mounting.

41. The method of claim 36, further comprising angularly positioning the at least one equipment support bar relative to the cross member, the at lea st one equipment support bar being angularly positionable for different angles of mounting and different types of vehicles.
